(19) United States
(12) Patent Application Publication
(10) Pub. No.: US 2024/0336209 A1
(43) Pub. Date: Oct. 10, 2024

(54) Decorative Covering, Interior Trim Part, and Method for Producing a Decorative Covering

(71) Applicant: Bayerische Motoren Werke Aktiengesellschaft, Muenchen (DE)

(72) Inventors: Thomas AUMANN, Buch am Erlbach (DE); Florian Dechant, Adlkofen (DE); Johann Gasslhuber, Buch am Erlbach (DE)

(21) Appl. No.: 18/627,629

(22) Filed: Apr. 5, 2024

(30) Foreign Application Priority Data
Apr. 6, 2023 (DE) 10 2023 108 802.5

(51) Int. Cl. B60R 13/02

(52) U.S. Cl. CPC B60R 13/02

(57) ABSTRACT

A decorative covering for an interior trim part includes at least two decorative parts, which are each realized in the form of a cloth-like sheet material with a plastics content, a first connecting end portion of the first decorative part and a second connecting end portion of the second decorative part being integrally bonded to one another in a connecting portion of the decorative covering. A method is provided for producing the decorative covering.

### CROSS REFERENCE TO RELATED APPLICATION

This application claims priority under 35 U.S.C. § 119 from German Patent Application No. DE 10 2023 108 802.5, filed Apr. 6, 2023, the entire disclosure of which is herein expressly incorporated by reference.

### BACKGROUND AND SUMMARY

The invention relates to a decorative covering, to an interior trim part, and to a method for producing a decorative covering.

An interior trim part is known from DE 10 2005 016 262 B4.

An object of the present invention is to provide a decorative covering which is an alternative to known decorative coverings.

Another object of the present invention is to provide an interior trim part for installation in a motor vehicle interior which is an alternative to known interior trim parts.

Another object of the present invention is to provide an efficient method for producing such an interior cladding part.

This object is achieved by the features of the independent claims. Further embodiments are specified in the dependent claims that refer back to each of these independent claims.

A first aspect of the invention provides a decorative covering for an interior trim part, which comprises: at least two decorative parts, which are each realized in the form of a cloth-like sheet material, at least one of the decorative parts having a plastics content, a first connecting end portion of the first decorative part and a second connecting end portion of the second decorative part being integrally bonded to one another in a connecting portion of the decorative covering.

Any embodiment of the decorative covering according to the invention with in principle any combination of features described herein of the decorative covering can be realized such that at least one of the two decorative parts is realized in the form of a textile sheet material and the plastics content is realized by plastics fibers present in the textile sheet material.

These embodiments of the decorative covering according to the invention may in particular be realized such that the textile sheet material is realized in one of the following forms or a combination of the following forms: a woven fabric, a warp-knitted fabric, a weft-knitted fabric, a braided fabric, a stitch-bonded fabric, a nonwoven, a felt.

Furthermore, embodiments of the decorative covering according to the invention may be realized such that at least one of the two decorative parts is realized in the form of a textile sheet material and the plastics content is realized by a plastics layer or a plastics film, which is placed at least on one of the two surfaces with a planar or areal extent of the textile sheet material.

Any embodiment of the decorative covering according to the invention with in principle any combination of features described herein of the decorative covering can be realized such that the textile sheet material with plastics fibers of at least one of the decorative parts is realized in the form of a 2D weft-knitted fabric or a 3D weft-knitted fabric.

Any embodiment of the decorative covering according to the invention with in principle any combination of features described herein of the decorative covering can be realized such that at least one of the two decorative parts comprises a plastics film or consists of a plastics film.

The embodiments of the decorative covering according to the invention with at least one decorative part made of a textile sheet material may in particular be realized such that the plastics film is a synthetic-leather sheet.

In this respect, the at least one of the two decorative parts may be realized such that it comprises a plastics film having a foam layer, with which the plastics film is coated, or consists of a plastics film with a foam layer, with which the plastics film is coated.

The embodiments of the decorative covering according to the invention with at least one decorative part made of a textile sheet material may in particular be realized such that the first connecting end portion of the first decorative part and the second connecting end portion of the second decorative part overlap one another in the connecting portion of the decorative covering and are integrally bonded to one another at least in one portion of the connecting portion.

The embodiments of the decorative covering according to the invention with at least one decorative part made of a textile sheet material may in particular be realized such that the first connecting end portion of the first decorative part and the second connecting end portion of the second decorative part abut one another in the connecting portion of the decorative covering and are integrally bonded to one another at least in one portion of mutually abutting edge portions.

In this respect, the connection of the first connecting end portion of the first decorative part and the second connecting end portion of the second decorative part may have at least one first portion realized with a mutually overlapping connection and at least one further portion realized with mutually abutting edge portions.

Another aspect of the invention provides an interior trim part which comprises:
a carrier device,
a decorative covering in an embodiment according to the invention, which is placed on a carrier region of the carrier device, the carrier region having at least one carrier device fastening portion and the decorative covering having a decorative covering contact region with at least one decorative covering fastening portion, a respective carrier device fastening portion and decorative covering fastening portion lying one on top of the other,
at least one pair respectively consisting of a carrier device fastening portion and a decorative covering fastening portion lying one on top of the other are connected to one another, it being possible for this connection to be detachable, in particular without damaging the interior trim part, for example a connection realized in the form of a clip connection or by means of at least one connecting element, and in general in the form of a mechanically detachable connection. In particular, this connection may be an integral bond, with the result that the decorative covering is fastened to the carrier region at least in the decorative covering contact region.

The interior trim part provided according to the invention may in particular be in the form of one of the following devices:
an instrument panel,
a door interior trim,
a seat trim, in particular a back-side seat trim,
a pillar trim,
a rear trim.

Another aspect of the invention provides a method for producing the decorative covering according to the invention, the integral bond being made in one or more of the following ways (a), (b), (c), (d), (e):
(a) by fusing the two fastening portions that lie one on the other by ultrasonic welding,
(b) by fusing the two fastening portions that lie one on the other by hot riveting,
(c) by fusing the two fastening portions that lie one on the other by feeding in hot air,
(d) by fusing the two fastening portions that lie one on the other by heat radiation,
(e) by fusing at least one portion of mutually abutting edge portions of the first decorative part and the second decorative part.

The fusing of at least one portion of mutually abutting edge portions of the first decorative part and the second decorative part can be done in particular by hot-tool welding.

In this document, the designation “installed state” is understood to mean the state of the interior trim part according to the invention in which the interior trim part is installed in the passenger compartment of a motor vehicle as functionally intended.

In this document, the term “textile” is understood to mean a material defined in accordance with DIN 60000.

The term “textile sheet material” is understood to mean a sheet material which extends areally in a longitudinal direction and a transverse direction, which extends transversely and in particular perpendicularly in relation to the longitudinal direction, and the thickness of which is at least two orders of magnitude smaller than the extent of the sheet material.

The term “seam shape arrangement” and terms derived therefrom with respect to the end portions provided according to the invention respectively of the first or second decorative part of the one connecting portion describe the arrangement, and possibly the cross-sectional profile, of the decorative parts as viewed in the longitudinal direction of the connecting portion of the decorative covering. However, this is not intended to express that the end portions are provided with a seam or connected to one another, in order to fasten them to one another. In the case of the “seam shape arrangement” mentioned in this document, surfaces of the first decorative part and surface portions of the second decorative part make contact and the decorative parts according to the invention are integrally bonded to one another in the region or in a partial region of the respective contact-making surfaces. The term “seam shape arrangement” and terms derived therefrom are used in this document to clearly define the position and the profiles of the end portions of the two decorative parts relative to one another.

Other objects, advantages and novel features of the present invention will become apparent from the following detailed description of one or more preferred embodiments when considered in conjunction with the accompanying drawing.

### BRIEF DESCRIPTION OF THE DRAWING

FIG. 1 is a schematic illustration of a plan view of a portion of an embodiment of an interior trim part according to the invention.

### DETAILED DESCRIPTION OF THE DRAWING

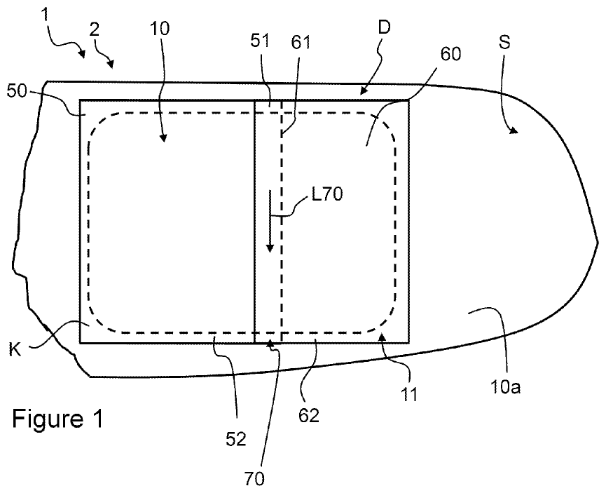

The following text describes embodiments of the invention on the basis of the appended FIG. 1. In this document, the description of features or components of embodiments according to the invention is to be understood such that, unless it is explicitly ruled out, according to the invention a relevant embodiment may also comprise at least one feature of another embodiment, in each case as an additional feature of this relevant embodiment or as an alternative feature that replaces another feature of this relevant embodiment.

FIG. 1 shows a schematic illustration of a plan view of a portion of an embodiment of an interior trim part according to the invention, for example in the form of an instrument panel with a carrier region and a decorative covering according to the invention arranged thereon.

The decorative covering D is intended for fastening to an outer surface 10a of an interior trim part 1 by means of a carrier device 2.

The decorative covering D generally has at least two decorative parts 50, 60, which are each realized in the form of a cloth-like sheet material with a plastics content. A first connecting end portion 51 of the first decorative part 50 and a second connecting end portion 61 of the second decorative part 60 are integrally bonded to one another in a connecting portion 70 of the decorative covering D.

The decorative covering D may also have more than two decorative parts, two respective decorative parts being integrally bonded to one another in a respective connecting portion 70 of the decorative covering D.

The integral bond between the two is made in that, in the connecting portion 70 of the decorative covering D, at least one surface portion of the first connecting end portion 51 of the first decorative part 50 and at least one surface portion of the second connecting end portion 61 of the second decorative part 60 abut one another, lie against one another with an overlap, or lie against one another completely covering one another, that is to say are in contact with one another. The plastics content present in at least one of the decorative parts 50, 60 is used to integrally bond at least one surface portion of the first connecting end portion 51 of the first decorative part 50 and at least one surface portion of the second connecting end portion 61 of the second decorative part 60. The position and the profile of the connecting end portions 51, 52 relative to one another for the integral bond thereof can be effected according to the invention in various ways.

One embodiment of the decorative covering D according to the invention, this embodiment being illustrated in FIG. 1, has a connecting portion 70 of the decorative covering D, in which the first connecting end portion 51 of the first decorative part 50 and the second connecting end portion 61 of the second decorative part 60 lie one on top of the other in the connecting end portion 70 of the decorative covering D, that is to say mutually overlap when seen in plan view, and are integrally bonded to one another at least in one portion of the connecting portion 70.

Another embodiment of the decorative covering D according to the invention has a connecting portion 70 of the decorative covering D, in which the first connecting end portion 51 of the first decorative part 50 and the second connecting end portion 61 of the second decorative part 60 abut one another, with the result that respective edge portions of the end portions 51, 62 make mutual contact. In this case, the mutually abutting edge portions of the first decorative part 50 and the second decorative part 60 are integrally bonded to one another at least in one portion.

As an alternative to this, the decorative covering D may be realized such that one of the two decorative parts 50, 60 completely covers the respective other decorative part, the decorative parts 50, 60 being integrally bonded to one another at least in one portion of this mutual coverage.

Further embodiments of the decorative covering D according to the invention have a connecting portion 70 of the decorative covering D in which the first connecting end portion 51 of the first decorative part 50 and the second connecting end portion 61 of the second decorative part 60 overlap one another and specifically, as seen in the cross section of the connecting portion 70 and in the direction of a longitudinal direction L70 thereof, extend relative to one another in one of the following seam shape arrangements and are integrally bonded to one another on mutually abutting surfaces:
(D1) flat felled seam arrangement,
(D2) double lapped seam arrangement,
(D3) flat seam arrangement.

In any embodiment of the decorative covering according to the invention with in principle any combination of features described herein of the decorative covering, the decorative covering D may be realized such that it is also possible for more than two decorative parts 50, 60 to be integrally bonded to one another. In this case, it may be provided that, in the connecting portion 70, more than two decorative parts overlap one another and all of these decorative parts are integrally bonded to one another.

Another aspect of the invention provides an interior trim part 1 comprising a carrier device 2 and a decorative covering D in an embodiment according to the invention. Such an interior trim part 1 is shown schematically in FIG. 1. For example, the interior trim part 1 may be realized in the form of an instrument panel, a door interior trim, a seat trim, in particular a back-side seat trim, or a pillar trim.

According to the invention, the decorative covering D may be fastened on an interior trim part 1. The interior trim part 1 according to the invention is intended in particular for installation in a passenger compartment of a motor vehicle and has a carrier device 2 and the decorative covering D placed thereon. The decorative covering D is placed on a region of the carrier device 2 that is illustrated in FIG. 1 and denoted in this document by “carrier region” and the reference sign “10”.

The carrier device 2 may be produced from or made of a plastic, such as a polypropylene-(PP-) bonded fiber mat which is pressed, ABS, ABS-PC, polycarbonate or other plastics, in the form of an injection molded part. The carrier device 2 may be produced as one part or from multiple parts that are layered one on top of another. The carrier device 2 may be realized in the form of a curved plate and is realized in the form of a dimensionally stable structural component, with the result that it can be fastened to a bodywork structural part, in order to cover a preferably relatively large surface area of the bodywork structural part on the side of the passenger compartment.

The carrier device 10 has a first surface, which conventionally forms an outer surface or a visible side and faces toward the passenger compartment, and a second surface, which is situated opposite the first surface. In the illustration of FIGS. 1 and 2, a first surface 10a of the carrier region 10 is accordingly illustrated as the corresponding region of the first surface of the carrier device 2, while the second surface is not visible. The first surface 10a, which faces toward the passenger compartment of a motor vehicle and thus is placed on a visible side when the carrier device is installed in the passenger compartment of a motor vehicle and, for example, is fastened to a holding device of the bodywork. As an alternative to this, the carrier device 10 may be a main body of the interior trim part 1, the first surface 10a of which, for use in a motor vehicle, is lined with a decorative layer, the outer face of which thus forms a visible side of the interior trim part 1.

The carrier device is preferably designed such that the outer surface or first surface 10a, which forms the conventionally provided visible side, extends in a longitudinal direction and a transverse direction, which extends transversely and in particular perpendicularly in relation to the longitudinal direction, and the outer surface or first surface 10a forms an area of extent which forms the visible side of the carrier device in the installed state. In particular, the carrier device may have a plate-shaped form.

The carrier device 2 has a region on which the decorative covering D is placed. This region is referred to as carrier region 10 of the carrier device 2 in this document. The carrier region 10 has at least one carrier device fastening portion and the decorative covering D has a decorative covering contact region K with at least one decorative covering fastening portion. The decorative covering D makes contact with the carrier region 10 at least in the decorative covering contact region K, i.e. a respective carrier device fastening portion and decorative covering fastening portion lie against one another directly or indirectly, that is to say separated by an interlayer. At least one pair respectively consisting of a carrier device fastening portion and a decorative covering fastening portion lie one on top of the other and are integrally bonded to one another.

Another aspect of the invention provides a method for producing an embodiment according to the invention of the decorative covering D, the integral bond being made in one or more of the following ways (a), (b), (c), (d), (e):
(a) by fusing the two fastening portions 51, 61 that lie on one another by ultrasonic welding,
(b) by fusing the two fastening portions 51, 61 that lie one on the other by hot riveting,
(c) by fusing the two fastening portions 51, 61 that lie one on the other by feeding in hot air,
(d) by fusing the two fastening portions 51, 61 that lie one on the other by heat radiation,
(e) by fusing at least one portion of mutually abutting edge portions of the first decorative part 50 and the second decorative part 60, it being possible for the fusing of at least one portion of mutually abutting edge portions of the first decorative part and the second decorative part to be done in particular by heated-tool welding.

### LIST OF REFERENCE SIGNS

1 Interior trim part
2 Carrier device
10 Carrier region
50 Decorative part
51 Connecting end portion of the decorative part 50
60 Decorative part
61 Connecting end portion of the decorative part 60
70 Connecting portion of the decorative covering D
D Decorative covering
K Decorative covering contact region of the decorative part 50
L70 Longitudinal direction of the connecting portion 70

What is claimed is:

1. A decorative covering for an interior trim part, comprising:
at least two decorative parts, which each comprise a cloth-like sheet material, at least one of the two decorative parts having a plastics content;
a first connecting end portion of a first of the two decorative part and a second connecting end portion of a second of the two decorative part integrally bonded to one another in a connecting portion of the decorative covering.

2. The decorative covering according to claim 1, wherein
at least one of the two decorative parts is in a form of a textile sheet material and the plastics content is realized by plastics fibers present in the textile sheet material.

3. The decorative covering according to claim 2, wherein
the textile sheet material is realized in one of the following forms or a combination of the following forms:
a woven fabric, a warp-knitted fabric, a weft-knitted fabric, a braided fabric, a stitch-bonded fabric, a nonwoven, or a felt.

4. The decorative covering according to claim 1, wherein
at least one of the two decorative parts is in a form of a textile sheet material and the plastics content is realized by a plastics layer or a plastics film, which is placed at least on one of the two surfaces of the textile sheet material.

5. The decorative covering according to claim 2, wherein
the textile sheet material with plastics fibers of at least one of the decorative parts is realized in the form of a 2D weft-knitted fabric or a 3D weft-knitted fabric.

6. The decorative covering according to claim 1, wherein
at least one of the two decorative parts comprises a plastics film.

7. The decorative covering according to claim 6, wherein the plastics film is a synthetic-leather sheet.

8. The decorative covering according to claim 6, wherein
the at least one of the two decorative parts comprises a plastics film having a foam layer, with which the plastics film is coated.

9. The decorative covering according to claim 1, wherein
the first connecting end portion of the first decorative part and the second connecting end portion of the second decorative part overlap one another in the connecting portion of the decorative covering and are integrally bonded to one another at least in one portion of the connecting portion.

10. The decorative covering according to claim 1, wherein
the first connecting end portion of the first decorative part and the second connecting end portion of the second decorative part abut one another in the connecting portion of the decorative covering and are integrally bonded to one another at least in one portion of mutually abutting edge portions.

11. The decorative covering according to claim 1, wherein
the first connecting end portion of the first decorative part and the second connecting end portion of the second decorative part in the connecting portion of the decorative covering, in a cross section of the connecting portion and in a direction of a longitudinal direction thereof, extend relative to one another and are integrally bonded to one another on mutually abutting surfaces in one of the following seam shape arrangements:
(D1) a flat felled seam arrangement,
(D2) a double lapped seam arrangement, or
(D3) a flat seam arrangement.

12. An interior trim part, comprising:
a carrier device;
a decorative covering placed on a carrier region of the carrier device, wherein the decorative covering comprises at least two decorative parts, which each comprise a cloth-like sheet material, at least one of the two decorative parts having a plastics content, and wherein a first connecting end portion of a first of the two decorative part and a second connecting end portion of a second of the two decorative part are integrally bonded to one another in a connecting portion of the decorative covering;
wherein the carrier region has at least one carrier device fastening portion and the decorative covering having a decorative covering contact region with at least one decorative covering fastening portion, a respective carrier device fastening portion and decorative covering fastening portion lying one on top of the other,
wherein each decorative covering fastening portion on a carrier device fastening portion of at least one pair respectively consisting of a carrier device fastening portion and a decorative covering fastening portion being connected to one another, whereby the decorative covering is fastened to the carrier region at least in the decorative covering contact region.

13. The interior trim part according to claim 12, wherein
each decorative covering fastening portion on a carrier device fastening portion of at least one pair respectively consisting of the carrier device fastening portion and the decorative covering fastening portion are integrally bonded to one another.

14. The interior trim part according to claim 12, wherein
each decorative covering fastening portion on a carrier device fastening portion of at least one pair respectively consisting of the carrier device fastening portion and the decorative covering fastening portion are interchangeably connected to one another.

15. The interior trim part according to claim 12, wherein the interior trim part is in the form of one of the following components:
an instrument panel,
a door interior trim,
a seat trim,
a back-side seat trim,
a pillar trim, or
a rear trim.

16. A method for producing a decorative covering having at least two decorative parts, which each comprise a cloth-like sheet material, at least one of the two decorative parts having a plastics content, the method comprising:
Integrally bonding a first connecting end portion of a first of the two decorative part and a second connecting end portion of a second of the two decorative part to one another in a connecting portion of the decorative covering, wherein the integrally bonding is carried out by one or more of:
(a) fusing the two fastening portions that lie one on the other by ultrasonic welding,
(b) fusing the two fastening portions that lie one on the other by hot riveting,
(c) fusing the two fastening portions that lie one on the other by feeding in hot air,
(d) fusing the two fastening portions that lie one on the other by heat radiation, or
(e) fusing at least one portion of mutually abutting edge portions of the first decorative part and the second decorative part.

17. The method for producing the decorative covering according to claim 16, wherein
the fusing of at least the portion of mutually abutting edge portions of the first decorative part and the second decorative part is done by heated-tool welding.
